(19) United States
(12) Patent Application Publication
(10) Pub. No.: US 2025/0390106 A1
(43) Pub. Date: Dec. 25, 2025

(54) SOCIAL-FRIENDLY NAVIGATION ALGORITHM-BASED ROBOT

(71) Applicant: SEOUL NATIONAL UNIVERSITY R&DB FOUNDATION, Seoul (KR)

(72) Inventors: Songhwai OH, Seoul (KR); Jeongwoo OH, Seoul (KR)

(21) Appl. No.: 19/307,896

(22) Filed: Aug. 22, 2025

Related U.S. Application Data
(63) Continuation of application No. PCT/KR2023/003788, filed on Mar. 22, 2023.

(30) Foreign Application Priority Data
Feb. 24, 2023 (KR) 10-2023-0025318

(51) Int. Cl. G05D 1/644; G05D 101/15

(52) U.S. Cl. CPC G05D 1/644; G05D 2101/15

(57) ABSTRACT

An embodiment relates to a robot executing a social-friendly navigation algorithm. The robot may include a communication unit, an input unit, a driving unit configured to move the robot, a memory, and at least one processor connected to the memory and configured to execute computer-readable instructions stored in the memory. By performing neural network computation using a separate processor and utilizing multiple processors in parallel, device efficiency may be improved.

### CROSS-REFERENCE TO RELATED APPLICATION

This application is a continuation of PCT Patent Application No. PCT/KR2023/003788 filed on Mar. 22, 2023, which claims priority to Korean Patent Application No. 10-2023-0025318, filed on Feb. 24, 2023, in the Korean Intellectual Property Office, the disclosure of which is incorporated by reference herein in its entirety.

### BACKGROUND

### 1. Field

The present disclosure relates to a robot. More specifically, the present disclosure relates to a robot that executes a social-friendly navigation algorithm and a method for moving the same.

### 2. Description of the Related Art

According to a market survey on service robots conducted by a well-known research institute, the market size of service robots is expected to grow to 36.2 billion USD by 2021 and to 103.3 billion USD by 2026.

In the past, companies typically received and utilized a small number of service robots. However, in the future, with the advancement of navigation systems, it is highly likely that companies will receive and utilize a large number of service robots to provide personalized services to customers.

Conventional AI navigation algorithms had limitations in that they recognized humans as stationary obstacles or controlled movement based on the assumption that human movement is irrelevant to the robot's movement.

In reality, however, humans are moving obstacles and simultaneously entities that interact with their surroundings. Therefore, a navigation algorithm that takes such factors into account is necessary.

In addition, when a robot travels, it is necessary to perform path planning not only for the final destination but also for intermediate waypoints to reach the destination. In order to calculate appropriate waypoints, it is required to consider the surrounding environment and especially to predict how moving obstacles such as humans will move.

### SUMMARY

An embodiment disclosed herein aims to provide a robot that, when selecting intermediate waypoints during movement toward a destination, includes a separate processor for performing neural network computation and utilizes multiple processors simultaneously in parallel.

The problems to be solved by the present disclosure are not limited to those mentioned above, and other problems not explicitly mentioned will be clearly understood by those skilled in the art based on the following description.

According to an aspect of the present disclosure, a method for moving a robot equipped with a social-friendly navigation algorithm executed by a first processor includes: a first step of collecting information on a departure point, a destination, pedestrians, and a map; a second step of searching for one or more candidate waypoints for reaching the destination; a third step of evaluating the value of the candidate waypoints by using global motion information in a Monte Carlo Tree Search (MCTS) operation; a fourth step of selecting a candidate waypoint that satisfies a predetermined criterion; and a fifth step of moving to the selected candidate waypoint.

The method may repeat the second to fifth steps until the robot reaches the destination or satisfies a predetermined stop condition and the global motion information is output by a neural network computation performed by a second processor, pedestrian interaction is excluded.

In the second step, one or more candidate waypoints may be searched based on a costmap and a cost function extracted from the pedestrian.

In the third step, the global motion information may be output by a global motion model, which may be trained based on encoded feature information of a segmented map and the past movement patterns of the pedestrian using a neural network-based model.

The third step may include generating a Monte Carlo tree for each of the searched candidate waypoints, and the fourth step may include selecting a candidate waypoint by comparing the values of root nodes of the generated Monte Carlo trees.

The third step may also include performing a value evaluation of the candidate waypoints by using the global motion information and assuming a predetermined movement distance of the pedestrian to generate local motion information reflecting pedestrian interaction, and applying the local motion information to the Monte Carlo Tree Search operation based on the output values of a reward function and a cost function.

The Monte Carlo Tree Search (MCTS) operation may include a selection process, an expansion process, a simulation process, and a backpropagation process.

The selection process may include a sampling procedure based on weights from a root node to a leaf node, and when the number of visits to the leaf node exceeds a predetermined threshold, the expansion process may be performed.

The simulation process may include calculating the weight of the leaf node based on a reward computation that increases the score as the robot approaches the destination, and a cost computation that decreases the score as the robot approaches a pedestrian or obstacle.

The simulation process may also include a step of reflecting an expected discounted total reward in the reward computation and an expected discounted total cost in the cost computation, assuming the robot would reach the destination even if it has not yet reached it.

The backpropagation process may include updating the value evaluation of nodes while moving from the leaf node to the root node.

Further, a robot that executes a social-friendly navigation algorithm according to an aspect of the present disclosure may include: a communication unit; an input unit; a driving unit that moves the robot; a memory; and at least one processor connected to the memory and configured to execute computer-readable instructions stored in the memory.

A first processor included in the at least one processor may be configured to perform: a first operation of collecting information on a departure point, a destination, pedestrians, and a map via the communication unit or the input unit; a second operation of searching for one or more candidate waypoints for reaching the destination; a third operation of evaluating the value of the candidate waypoints using global motion information in a Monte Carlo Tree Search (MCTS) operation; a fourth operation of selecting a candidate waypoint that satisfies a predetermined criterion; and a fifth operation of executing a command for moving to the selected candidate waypoint via the driving unit.

The first processor may be configured to repeatedly perform the second to fifth operations until the robot reaches the destination or satisfies a predetermined stop condition and the global motion information is output by a neural network computation performed by a second processor, pedestrian interactions is excluded.

The first processor may be configured to search for one or more candidate waypoints based on a costmap and a cost function extracted from pedestrians.

The global motion information may be output by a global motion model, and the global motion model may be trained based on encoded feature information of a segmented map and past movement patterns of pedestrians using a neural network-based model.

The first processor may be configured to generate a Monte Carlo tree for each of the searched candidate waypoints and to select a candidate waypoint by comparing the values of root nodes of the generated Monte Carlo trees.

The first processor may be configured to perform a value evaluation of the candidate waypoints based on the output values of a reward function and a cost function, by using local motion information, which is generated based on both the global motion information and a predetermined pedestrian movement assumption, and reflects pedestrian interaction, in a Monte Carlo Tree Search operation.

The Monte Carlo Tree Search operation may include a selection process, an expansion process, a simulation process, and a backpropagation process.

The first processor may be configured to perform a sampling process based on weights from the root node to the leaf node during the selection process, and when the number of visits to the leaf node exceeds a predetermined threshold, to perform the expansion process.

The first processor may be configured to calculate the weight of the leaf node during the simulation process based on a reward computation in which the score increases as the robot approaches the destination and a cost computation in which the score decreases as the robot approaches pedestrians or obstacles.

The first processor may be configured to reflect an expected discounted total reward in the reward computation and an expected discounted total cost in the cost computation, assuming that the robot reaches the destination even if it has not yet reached it, during the simulation process.

The first processor may be configured to update the value evaluation of nodes during the backpropagation process by moving from the leaf node to the root node.

Additionally, a computer-readable recording medium storing a computer program for executing the implementation of the present disclosure may also be provided.

Furthermore, a computer-readable recording medium on which a computer program for executing the method of implementing the present disclosure is recorded may also be provided.

According to the means for solving the problems described above, when the robot selects an intermediate waypoint while moving toward the destination, the use of a separate processor to perform computationally intensive neural network operations can reduce the computational cost of intermediate waypoint navigation and improve device efficiency.

The effects of the present disclosure are not limited to those mentioned above, and other effects not explicitly described will be clearly understood by those skilled in the art based on the following description.

### BRIEF DESCRIPTION OF THE DRAWINGS

FIG. 1 illustrates a robot utilizing a social-friendly navigation algorithm according to the present disclosure in a schematic manner.

FIG. 2 is a block diagram illustrating the configuration of a robot according to the present disclosure.

FIG. 3 is a sequence diagram for explaining a movement method of the robot according to the present disclosure.

FIG. 4 illustrates a method for performing value evaluation on candidate waypoints according to the present disclosure.

FIG. 5 illustrates an exemplary process in which the robot moves to a destination according to the present disclosure.

### DETAILED DESCRIPTION

Throughout the present disclosure, the same reference numerals refer to the same components. The present disclosure does not describe all elements of embodiments, and general content in the technical field to which the present disclosure pertains, or overlapping content among embodiments, is omitted. The terms “unit,” “module,” “member,” and “block” used in the specification may be implemented in software or hardware, and depending on the embodiments, multiple units, modules, members, or blocks may be implemented as a single component, or a single unit, module, member, or block may include multiple components.

In the specification, when a part is said to be “connected” to another part, it includes both direct connections and indirect connections, where the indirect connections may include connections via a wireless communication network.

Also, when a part is said to “include” a component, unless otherwise specified, this does not exclude the presence of other components and may include additional components.

Throughout the specification, when one member is “on” another member, it includes cases where the member is in contact with the other member as well as cases where another member is interposed therebetween.

The terms “first,” “second,” and so on are used to distinguish one component from another and are not intended to limit the components by those terms.

Unless clearly indicated otherwise by the context, singular expressions shall include the plural.

Identification numerals used in each step are for convenience of explanation and do not indicate the order of the steps. Unless a specific order is clearly indicated by the context, each step may be performed in a different order than that described.

Hereinafter, the operational principles and embodiments of the present disclosure will be described with reference to the accompanying drawings.

Functions related to artificial intelligence according to the present disclosure are operated through a processor and a memory. The processor may be configured as one or more processors. The one or more processors may include general-purpose processors such as a CPU, AP, or DSP (Digital Signal Processor), graphics-dedicated processors such as a GPU (Graphics Processing Unit) or VPU (Vision Processing Unit), or artificial intelligence-dedicated processors such as an NPU (Neural Processing Unit). The one or more processors control processing of input data based on predefined operation rules or an artificial intelligence model stored in the memory. Alternatively, if the one or more processors are artificial intelligence-dedicated processors, such processors may be designed with a hardware structure specialized for processing specific artificial intelligence models.

The predefined operation rules or artificial intelligence model are characterized in that they are created through training. Here, “created through training” means that a predefined operation rule or artificial intelligence model, configured to perform desired characteristics (or objectives), is created by training a base artificial intelligence model using a plurality of training data through a training algorithm. Such training may be performed on the device itself where the artificial intelligence of the present disclosure is executed, or through a separate server and/or system. Examples of training algorithms include supervised learning, unsupervised learning, semi-supervised learning, or reinforcement learning, but are not limited thereto.

The artificial intelligence model may include a plurality of neural network layers. Each of the plurality of neural network layers may have a plurality of weight values and performs neural network computation through operations between the result of a previous layer and the plurality of weight values. The plurality of weight values included in the plurality of neural network layers may be optimized by the result of training the artificial intelligence model. For example, during training, the weight values may be updated to decrease or minimize the loss or cost value acquired in the artificial intelligence model. The artificial neural network may include a deep neural network (DNN), and examples thereof include, but are not limited to, a convolutional neural network (CNN), deep neural network (DNN), recurrent neural network (RNN), restricted Boltzmann machine (RBM), deep belief network (DBN), bidirectional recurrent deep neural network (BRDNN), deep Q-networks, a Unet-based network, or a Ynet-based network.

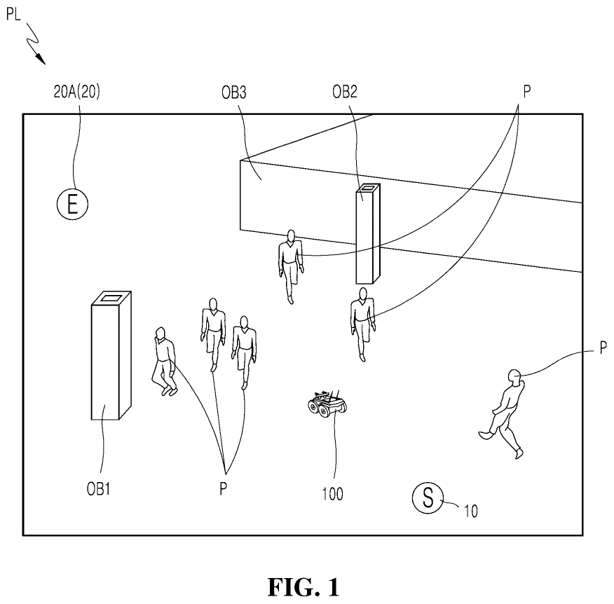

FIG. 1 is a schematic diagram illustrating a robot (100) utilizing a social-friendly navigation algorithm according to the present disclosure.

The robot (100) may move from a departure point (10) to a destination (20A) (20), and may execute a social-friendly navigation algorithm to move without colliding with nearby pedestrians (P) or obstacles (OB1-OB3). The robot (100) may move using a means of locomotion such as wheels and/or a driving unit. However, the locomotion means may be implemented in various ways depending on the embodiment.

Additionally, when traveling, the robot (100) may perform path planning not only to the final destination but also for intermediate waypoints, and in order to calculate appropriate waypoints, it may consider the surrounding environment and particularly predict how moving obstacles such as humans may move.

The robot (100) may collect information such as the departure point (10), the destination (20A) (20), pedestrians (P), obstacles (OB1-OB3), and a map, and move from the departure point (10) to the destination (20A). During movement, the robot may utilize the social-friendly navigation algorithm to avoid collisions with both dynamic obstacles including pedestrians (P) and static obstacles.

When applying the social-friendly navigation algorithm, the robot (100) may utilize multiple processors in parallel, and particularly perform neural network-based computation through a specific processor. The result values of the computation may be collected in real time and utilized by a separate processor in real time.

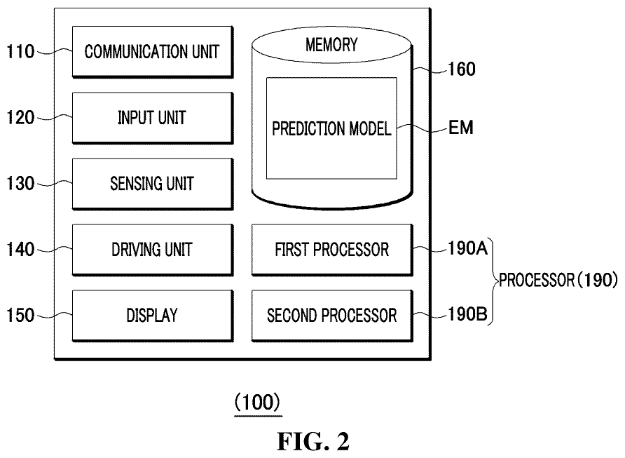

FIG. 2 is a block diagram illustrating the configuration of the robot (100) according to the present disclosure.

The robot (100) according to the present disclosure may include a communication unit (110), an input unit (120), a sensing unit (130), a driving unit (140), a display (150), a memory (160), and at least one processor (190). The components illustrated in FIG. 2 are not essential for implementing the robot (100) of the present disclosure, and the robot (100) described in this specification may include more or fewer components than those listed above.

Among the components, the communication unit (110) may include one or more elements that enable communication with external devices. For example, it may include at least one of a broadcast receiving module, a wired communication module, a wireless communication module, a short-range communication module, or a location information module.

The wired communication module may include various types of wired communication modules such as a Local Area Network (LAN) module, a Wide Area Network (WAN) module, or a Value Added Network (VAN) module, as well as various cable communication modules such as Universal Serial Bus (USB), High Definition Multimedia Interface (HDMI), Digital Visual Interface (DVI), Recommended Standard 232 (RS-232), power line communication, or Plain Old Telephone Service (POTS).

The wireless communication module may include, in addition to a Wi-Fi module or a Wireless Broadband (WiBro) module, wireless communication modules supporting various wireless communication standards such as Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), 4G, 5G, or 6G.

The wireless communication module may include a wireless communication interface that includes an antenna and a transmitter for transmitting wireless communication signals. In addition, the wireless communication module may further include a signal conversion module that modulates a digital control signal output from a controller into an analog wireless signal through the wireless communication interface under the control of the processor.

The wireless communication module may include a wireless communication interface that includes an antenna and a receiver for receiving wireless communication signals. Furthermore, the wireless communication module may further include a signal conversion module that demodulates analog wireless signals received via the wireless communication interface into digital control signals.

The short-range communication module is for supporting short-range communication, and may support short-range communication using at least one of technologies such as Bluetooth™, RFID (Radio Frequency Identification), infrared communication (IrDA: Infrared Data Association), UWB (Ultra Wideband), ZigBee, NFC (Near Field Communication), Wi-Fi (Wireless Fidelity), Wi-Fi Direct, and Wireless USB (Wireless Universal Serial Bus).

The location information module is a module for acquiring the location (or current position) of the device according to the present disclosure. Representative examples include a GPS (Global Positioning System) module or a Wi-Fi (Wireless Fidelity) module. For example, when using a GPS module, the device may acquire its location using signals transmitted from GPS satellites. In another example, when using a Wi-Fi module, the device may acquire its location based on the information of a wireless access point (AP) that transmits or receives wireless signals with the Wi-Fi module. If necessary, the location information module may perform the function of another module of the communication unit to obtain data regarding the location of the device in a substitutive or supplementary manner. The location information module is used to obtain the location (or current position) of the device and is not limited to a module that directly calculates or acquires the position of the device.

The input unit (120) is for receiving image information (or signals), audio information (or signals), data, or information input by a user, and may include at least one camera, at least one microphone, and at least one user input component. Voice data or image data collected through the input unit may be analyzed and processed as control commands from the user.

The camera processes image frames such as still images or moving images obtained by an image sensor in a shooting mode. The processed image frames may be displayed on a display (150, the screen of the robot according to the present disclosure) or stored in memory. When there are a plurality of cameras, they may be arranged in a matrix structure. Through such matrix-structured cameras, multiple pieces of image information having various angles or focal points may be input. Additionally, the cameras may be arranged in a stereo structure to acquire left and right images for realizing a three-dimensional stereoscopic image.

The microphone processes external sound signals into electrical voice data. The processed voice data may be variously utilized depending on the functions being performed by the device (or the running application). Furthermore, various noise reduction algorithms may be implemented in the microphone to eliminate noise generated during the input of external sound signals.

The user input unit is for receiving information from a user, and when information is input through the user input unit, the controller may control the operation of the device in response to the input information. The user input unit may include hardware-based physical keys (e.g., buttons located on at least one of the front, rear, or side surfaces of the device, dome switches, jog wheels, jog switches, etc.) and software-based touch keys. As an example, the touch keys may include virtual keys, soft keys, or visual keys displayed on a touchscreen-type display through software processing, or may include touch keys arranged in areas other than the touchscreen. The virtual keys or visual keys may have various forms and may be displayed on the touchscreen. For example, they may be composed of graphics, text, icons, videos, or a combination thereof.

The sensing unit (130) senses at least one of information within the device (robot), surrounding environmental information, or user-related information, and generates a corresponding sensing signal. Based on the sensing signal, at least one processor may control the operation or actuation of the device, or may perform data processing, functionalities, or operations related to an application installed in the device.

The sensing unit (130) may include at least one of a proximity sensor, an illumination sensor, a touch sensor, an acceleration sensor, a magnetic sensor, a gravity sensor (G-sensor), a gyroscope sensor, a motion sensor, an RGB sensor, an infrared (IR) sensor, a fingerprint sensor, an ultrasonic sensor, an optical sensor (e.g., a camera), a microphone, an environmental sensor (e.g., including at least one of a barometer, a hygrometer, a thermometer, a radiation detector, a thermal detector, or a gas detector), and a chemical sensor (e.g., a healthcare sensor or a biometric sensor). The device may utilize a combination of information sensed by at least two or more of these sensors.

The driving unit (140) may include various components that enable the robot (100) to move.

The display (150) outputs information processed by the device. For example, the display may present information related to the execution screen of an application running on the device (e.g., an application), or UI (User Interface) or GUI (Graphical User Interface) information associated with such execution screens.

The memory (160) may store data supporting various functions of the device and programs for operating the processor. It may also store input/output data (e.g., music files, still images, videos, etc.), multiple application programs running on the device, data for operating the device, and instruction sets. At least some of these application programs may be downloaded from an external server via wireless communication.

The memory (160) may include at least one type of storage medium such as a flash memory type, hard disk type, solid state disk (SSD) type, silicon disk drive (SDD) type, multimedia card micro type, card-type memory (e.g., SD or XD memory), random access memory (RAM), static random access memory (SRAM), read-only memory (ROM), electrically erasable programmable read-only memory (EEPROM), programmable read-only memory (PROM), magnetic memory, magnetic disk, and optical disk. Additionally, the memory may be a database that is separate from the device but connected via wired or wireless communication.

The at least one processor (190) may be implemented as a memory storing data related to an algorithm for controlling operations of components within the device or a program replicating such an algorithm, and at least one processor (not shown) that performs the above-described operations using the data stored in the memory. In this case, the memory and the processor may be implemented as separate chips, or may be implemented as a single integrated chip.

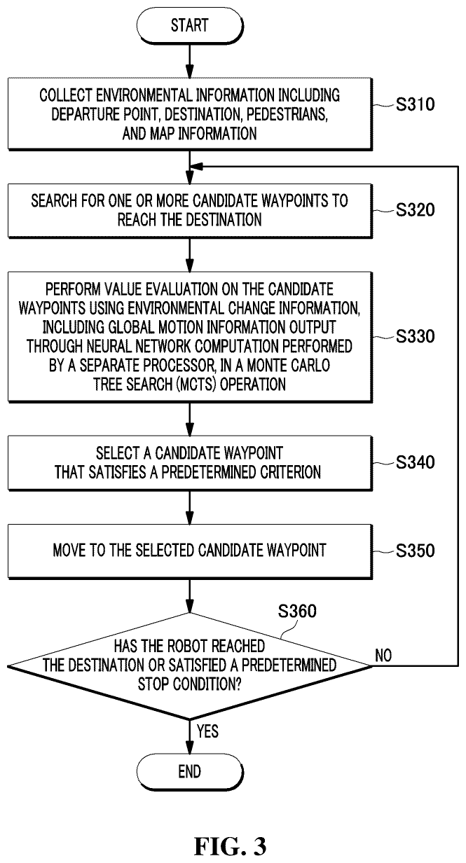

Additionally, the processor (190) may control one or more of the aforementioned components in combination in order to implement various embodiments of the present disclosure described in FIGS. 3 to 5 on the device.

In accordance with the performance of the components illustrated in FIG. 2, at least one component may be added or omitted. Furthermore, the relative positions of the components may be changed according to the performance or structure of the system, which will be readily understood by those skilled in the art.

Meanwhile, each of the components illustrated in FIG. 2 refers to software and/or hardware components such as a Field Programmable Gate Array (FPGA) or an Application Specific Integrated Circuit (ASIC).

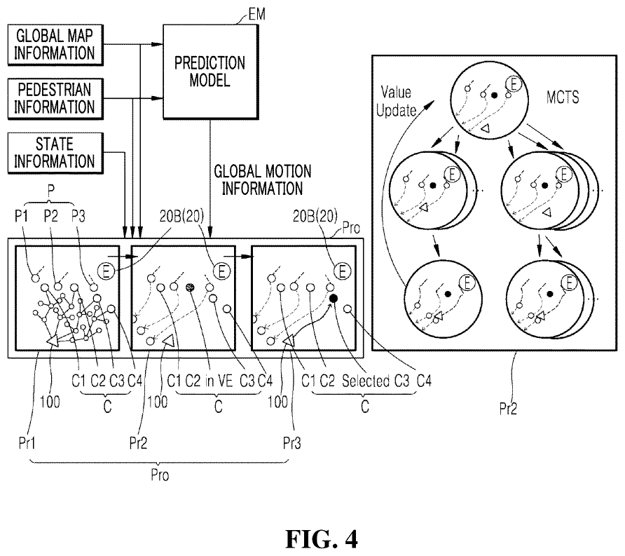

FIG. 3 is a sequence diagram for explaining a method of moving the robot (100) according to the present disclosure. FIG. 4 illustrates a method for performing value evaluation on candidate waypoints according to the present disclosure, and FIG. 4 will be referred to as necessary while explaining FIG. 3.

The movement method of the robot (100) may be primarily performed by a first processor (190A).

The first processor (190A) may collect information on the environment, including information on a departure point, a destination, pedestrians, and a map (S310).

The first processor (190A) may collect information on the departure point and/or destination via the communication unit (110) or the input unit (120), and may collect information on the statistical movement of pedestrians along the path from the departure point to the destination, obstacles on the path, and map data. In addition, the environmental information is not limited to the above-described content.

After step S310, the first processor (190A) may search for one or more candidate waypoints for reaching the destination (S320).

Here, the candidate waypoints serve as intermediate points toward the destination and may be arranged in various directions with respect to the direction of gravity. For example, they may be distributed in multiple directions (e.g., 9 directions) and may be arranged at a certain distance (e.g., several centimeters or more) from the current position of the robot (100). However, embodiments are not limited thereto.

The first processor (190A) may search for one or more candidate waypoints based on a costmap and a cost function extracted from pedestrian data.

Specifically, the cost function may be derived from both the costmap and the pedestrian data. The costmap may consider various types of costs, including global map costs, static obstacle costs, and costs caused by alternative paths. The global map cost may refer to the cost associated with being located near obstacles such as walls, pillars, or stairs. The static obstacle cost may refer to the cost caused by static obstacles detected in real time. However, the embodiment is not limited thereto.

Referring to FIG. 4, the first processor (190A) may search for a plurality of candidate waypoints (C1-C4) (C). At this time, the first processor (190A) may search for the candidate waypoints (C1-C4) (C) at predetermined angles and distances from the robot (100).

After step S320 of FIG. 3, the first processor (190A) may perform a value evaluation of the candidate waypoints by using environmental change information, including global motion information output through neural network computation performed by a separate second processor (190B), in a Monte Carlo Tree Search (MCTS) operation (S330).

Here, the first processor (190A) may be a CPU, and the second processor (190B) may be a GPU. However, embodiments are not limited thereto. The second processor (190B) may be located not only inside the robot (100) but also on an external computation server, with only the computation result being collected via the communication unit (110) or the input unit (120).

The second processor (190B) may output global motion information in which pedestrian interaction is excluded (or reduced). The global motion information may be output by a global motion model, which may be trained based on encoded feature information of a segmented map and past movement patterns of pedestrians using a neural network-based approach. The global motion model may be trained based on neural network algorithms such as Y-Net or U-Net; however, embodiments are not limited thereto.

In other words, the global motion information may exclude considerations such as collisions caused by movement between the robot (100) and pedestrians, the robot and obstacles, pedestrians and pedestrians, or obstacles and obstacles. Instead, it may only consider information such as map data, the number of pedestrians on specific movement paths of the robot (100), pedestrian movement patterns, occupancy time, and movement trajectories.

The robot (100) may activate a separate process for outputting global motion information by using the second processor (190B). The global motion information output by the second processor (190B) may be used in the Monte Carlo Tree Search (MCTS) operation performed by the first processor (190A) to evaluate the value of the candidate waypoints.

Referring to FIG. 4, a prediction model (EM) may output global motion information by receiving global map information and pedestrian information as inputs.

The first processor (190A) may search for candidate waypoints (Pr1), generate Monte Carlo trees for each of the candidate waypoints to perform value evaluations (Pr2), and select the most optimal candidate waypoint (C3) based on the evaluation results (Pr3).

Here, when the first processor (190A) performs a value evaluation on a second candidate waypoint (C2) as an example (Pr2), the value evaluation may be performed based on the following equation:

$$V = {λ}_{t} {V}_{t} + {λ}_{l} {V}_{l} + {λ}_{g} {V}_{g} \qquad [ Equation 1 ]$$

Here, V denotes the value evaluation result, and Vₜ may be obtained through the Monte Carlo Tree Search and represents a quality value that considers social friendliness. Vᵢ is used to adjust unstable movement at a fine control level and is inversely proportional to the distance from the previous candidate waypoint. Vg is inversely proportional to the distance to the destination, and a larger Vg may be assigned to a candidate that is closer to the destination. Each value may be multiplied by a corresponding hyperparameter. In addition to the value evaluation described above, the equation may be modified to increase the value in a direction that is advantageous for travel. In one embodiment, a value function suitable for the intended purpose may be user-defined and used for evaluation, instead of the form shown in [Equation 1].

The first processor (190A) of FIG. 3 may generate a Monte Carlo tree for each of the searched candidate waypoints. The first processor (190A) may use local motion information—obtained by assuming a predetermined distance of pedestrian movement and reflecting pedestrian interaction—based on the global motion information output by the second processor (190B), in the Monte Carlo Tree Search operation.

That is, the global motion information refers to the predicted movement of pedestrians without considering interaction between people and the robot, while the local motion information represents movement influenced by interaction with the surrounding environment encountered during movement predicted by the global motion.

In an embodiment, when determining the local motion information, the first processor (190A) may base the determination on factors such as proximity to the destination, proximity to obstacles, proximity to pedestrians, and application of random movement.

The first processor (190A) may generate a Monte Carlo tree for each candidate waypoint and, assuming that the robot (100) moves a predetermined distance, may perform value evaluation on the candidate waypoint based on the output values of a reward function and a cost function. These outputs may reflect changes in distance between the robot (100) and dynamic obstacles including pedestrians, the robot (100) and static obstacles, pedestrians and other pedestrians, and obstacles and other obstacles.

Here, the reward function may output a higher value as the robot gets closer to the destination, while the cost function may output a lower value as the probability of collision increases. That is, due to the robot's (100) virtual movement, the robot may move toward a location that is closer to the destination and has a lower probability of collision, based on a scoring system.

The Monte Carlo Tree Search operation may include a selection process, an expansion process, a simulation process, and a backpropagation process.

The selection process may include a sampling procedure based on weights from the root node to a leaf node, and if the number of visits to the leaf node exceeds a predetermined threshold, the expansion process may be performed to hierarchically increase the number of nodes.

In the selection process, the first processor (190A) may perform sampling based on weights w(s, a) from the root node to the leaf node.

Here, s refers to state information and may include information such as the location of the robot (100), the location of the destination, and map data. However, embodiments are not limited thereto.

The simulation process may include calculating the weight of the leaf node based on a reward computation that increases the score as the robot approaches the destination, and a cost computation that decreases the score as the robot approaches pedestrians or obstacles.

If the robot does not reach the destination during the simulation process, the process may assume that the robot does reach the destination. In such case, the expected discounted total reward, based on the cumulative reward obtained during the simulation, may be reflected in the reward computation, and the expected discounted total cost, based on the cumulative cost obtained during the simulation, may be reflected in the cost computation. The term “expected discount” refers to a decrease in value over time (e.g., exponentially), and it may be used to define the upper and lower bounds of the expected total reward and cost.

The tree update process may include updating the value evaluation of nodes while traversing from the leaf node back to the root node.

After step S330, the first processor (190A) may select a candidate waypoint that satisfies a predetermined criterion (S340).

The first processor (190A) may move to the candidate waypoint with the highest score among the one or more candidate waypoints. This decision may be made by comparing the values of the root nodes corresponding to each candidate waypoint. As the value evaluation of each candidate waypoint is propagated to the root node, the waypoint may be selected simply by comparing the root node values for each candidate.

After step S340, the first processor (190A) may control the driving unit (140) to move the robot (100) to the selected candidate waypoint (S350).

In this case, the first processor (190A) may stop the movement of the robot (100) if the robot reaches the destination or satisfies a predetermined stop condition (S360). If not, the processor may repeatedly perform steps S320 to S350 to continue movement.

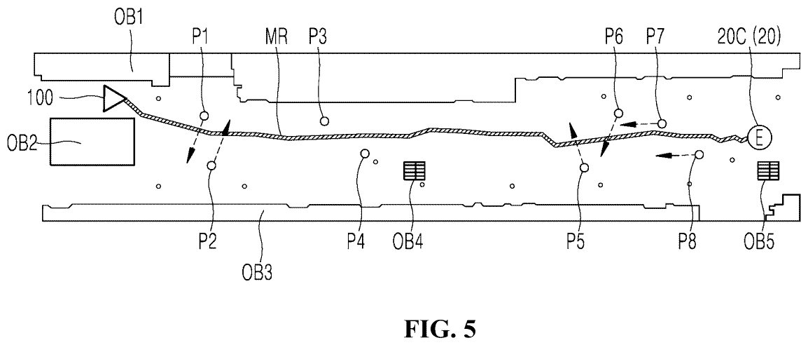

FIG. 5 is a diagram exemplarily illustrating a method by which the robot (100) moves to a destination according to the present disclosure.

Referring to FIG. 5, the robot (100) may move from a departure point to a destination (20C) (20), while effectively avoiding dynamic obstacles (P1-P8), including pedestrians, and static obstacles (OB1-OB5), as it approaches the destination.

At this time, the robot (100) may select intermediate candidate waypoints based on global motion information and local motion information, and may continue to move until it reaches the destination or satisfies a stop condition (e.g., timeout).

Meanwhile, the disclosed embodiments may be implemented in the form of a computer-readable recording medium storing instructions executable by a computer. The instructions may be stored as program code and, when executed by a processor, may generate program modules that perform the operations of the disclosed embodiments. The recording medium may be implemented as a computer-readable storage medium.

The computer-readable storage medium includes all types of media on which instructions decodable by a computer are stored. Examples include Read Only Memory (ROM), Random Access Memory (RAM), magnetic tapes, magnetic disks, flash memory, and optical data storage devices.

As described above, the disclosed embodiments have been explained with reference to the accompanying drawings. However, it will be understood by those skilled in the art that the present disclosure may be embodied in other forms without departing from the spirit or essential features of the disclosure. The disclosed embodiments are merely illustrative and should not be construed as limiting.

What is claimed is:

1. A method for moving a robot having a social-friendly navigation algorithm executed by a first processor, the method comprising:
a first step of collecting information on a departure point, a destination, pedestrians, and a map;
a second step of searching for one or more candidate waypoints for reaching the destination;
a third step of performing value evaluation on the candidate waypoints using global motion information in a Monte Carlo Tree Search (MCTS) operation;
a fourth step of selecting a candidate waypoint that satisfies a predetermined criterion; and
a fifth step of moving to the selected candidate waypoint,
wherein the method repeats the second to fifth steps until the robot reaches the destination or satisfies a predetermined stop condition, and
wherein the global motion information is output by a neural network computation performed by a second processor, pedestrian interaction is excluded.

2. The method of claim 1,
wherein the second step includes searching for one or more candidate waypoints based on a costmap and a cost function extracted from pedestrian data.

3. The method of claim 2,
wherein, in the third step, the global motion information is output by a global motion model, and the global motion model is trained based on encoded feature information of a segmented map and past movement patterns of pedestrians using a neural network-based approach.

4. The method of claim 3,
wherein the third step includes generating a Monte Carlo tree for each of the searched candidate waypoints,
and the fourth step includes selecting a candidate waypoint by comparing the values of the root nodes of the generated Monte Carlo trees.

5. The method of claim 4,
wherein the third step includes performing a value evaluation of the candidate waypoints based on output values of a reward function and a cost function, by using local motion information reflecting pedestrian interaction, the local motion information being generated based on global motion information and under an assumption that the pedestrian moves a predetermined distance, in a Monte Carlo Tree Search operation.

6. The method of claim 5,
wherein the Monte Carlo Tree Search operation includes a selection process, an expansion process, a simulation process, and a backpropagation process.

7. The method of claim 6,
wherein the selection process includes a sampling process based on weights from the root node to a leaf node,
and the expansion process is performed when the number of visits to the leaf node exceeds a predetermined threshold.

8. The method of claim 7,
wherein the simulation process includes calculating the weight of the leaf node based on a reward computation that increases the score as the robot approaches the destination and a cost computation that decreases the score as the robot approaches pedestrians or obstacles.

9. The method of claim 8,
wherein the simulation process includes reflecting an expected discounted total reward in the reward computation and an expected discounted total cost in the cost computation, assuming the robot reaches the destination even if it has not yet done so.

10. The method of claim 9,
wherein the tree update process includes updating the value evaluation of nodes while traversing from the leaf node to the root node.

11. A robot executing a social-friendly navigation algorithm, comprising:
a communication unit;
an input unit;
a driving unit configured to move the robot;
a memory; and
at least one processor connected to the memory and configured to execute computer-readable instructions stored in the memory,
wherein a first processor included in the at least one processor is configured to:
perform a first operation of collecting information on a departure point, a destination, pedestrians, and a map via the communication unit or the input unit;
perform a second operation of searching for one or more candidate waypoints for reaching the destination;
perform a third operation of evaluating the value of the candidate waypoints using global motion information in a Monte Carlo Tree Search (MCTS) operation;
perform a fourth operation of selecting a candidate waypoint that satisfies a predetermined criterion; and
perform a fifth operation of executing a command via the driving unit to move to the selected candidate waypoint,
wherein the first processor is further configured to repeatedly perform the second to fifth operations until the robot reaches the destination or satisfies a predetermined stop condition, and
wherein the global motion information is output by a neural network computation performed by a second processor, pedestrian interaction is excluded.

12. The robot of claim 11,
wherein the first processor is configured to search for one or more candidate waypoints based on a costmap and a cost function extracted from pedestrian data.

13. The robot of claim 12,
wherein the global motion information is output by a global motion model, and
the global motion model is trained based on encoded feature information of a segmented map and past movement patterns of pedestrians using a neural network-based approach.

14. The robot of claim 13,
wherein the first processor is configured to generate a Monte Carlo tree for each of the searched candidate waypoints, and to select a candidate waypoint by comparing the values of the root nodes of the generated Monte Carlo trees.

15. The robot of claim 14,
wherein the first processor is configured to perform a value evaluation of the candidate waypoints based on output values of a reward function and a cost function, by using local motion information reflecting pedestrian interaction, the local motion information being generated based on global motion information and under an assumption that the pedestrian moves a predetermined distance, in a Monte Carlo Tree Search operation.

16. The robot of claim 15,
wherein the Monte Carlo Tree Search operation includes a selection process, an expansion process, a simulation process, and a backpropagation process.

17. The robot of claim 16,
wherein the first processor is configured to perform a sampling process based on weights from the root node to the leaf node in the selection process, and to perform the expansion process when the number of visits to the leaf node exceeds a predetermined threshold.

18. The robot of claim 17,
wherein the first processor is configured to calculate the weight of the leaf node in the simulation process based on a reward computation that increases the score as the robot approaches the destination and a cost computation that decreases the score as the robot approaches pedestrians or obstacles.

19. The robot of claim 18,
wherein the first processor is configured to reflect an expected discounted total reward in the reward computation and an expected discounted total cost in the cost computation in the simulation process, assuming that the robot reaches the destination even if it has not yet done so.

20. The robot of claim 19,
wherein the first processor is configured to perform a value update of the nodes in the tree update process while traversing from the leaf node to the root node.

21. A program stored in a computer-readable recording medium, which, when executed in conjunction with a computer, performs the method for moving the robot according to claim 1.
